(19) United States
(12) Patent Application Publication
(10) Pub. No.: US 2019/0101922 A1
(43) Pub. Date: Apr. 4, 2019

(54) AUTONOMOUS OR SEMI-AUTONOMOUS PARKING METHOD AND APPARATUS

(71) Applicant: Intel Corporation, Santa Clara, CA (US)

(72) Inventor: Naoki Matsumura, San Jose, CA (US)

(21) Appl. No.: 15/721,102

(22) Filed: Sep. 29, 2017

(51) Int. Cl. G05D 1/02; G05D 1/00; G01S 19/45

(52) U.S. Cl. CPC G05D 1/0212; G05D 1/0088; H04L 67/12; G01S 19/45; G05D 1/0016

(57) ABSTRACT

Apparatuses, methods and storage media associated with autonomously or semi-autonomously parking a vehicle are disclosed herein. In embodiments, an apparatus may include a communication interface to receive sensor data associated with environmental condition of an area around or adjacent to a vehicle; and a parking condition analysis unit coupled to the communication interface to determine, while the vehicle is parked in a current parking position, whether there is a new parking position for the vehicle, that provides a new parking condition that is an improvement over a current parking condition of the current parking position of the vehicle, based at least in part on the received sensor data. Other embodiments may be disclosed and claimed.

### TECHNICAL FIELD

The present disclosure relates to the field of autonomous or semi-autonomous vehicles, in particular, to methods, apparatuses, and storage medium associated with autonomous or semi-autonomous parking of a vehicle.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

Electric vehicles (such as, car, drones, etc) have become increasingly popular in recent years. Most electric vehicles use Li-ion battery, which is one of the key and expensive component. For example, a 2015 Nissan Leaf costs ˜$30 k, and its Li-ion battery pack may cost $5.5 k. Battery is degraded by charge/discharge (drive) cycles and is also degraded at elevated temperature. For example, longevity of Li-ion battery is ˜8 years at 70-75 degrees Fahrenheit, but is only ˜4 years at 100 degrees Fahrenheit.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIGS. 1a-1c illustrate an overview of autonomous or semi-autonomous parking of a vehicle, in accordance with various embodiments.

FIG. 2 illustrates a block diagram view of an example computer-assisted or autonomous driving system, in accordance with various embodiments.

FIG. 3 illustrates an example process for autonomously or semi-autonomously parking a vehicle, in accordance with various embodiments.

FIG. 4 illustrates an example computer system, suitable for use to practice the present disclosure (or aspects thereof), in accordance with various embodiments.

FIG. 5 illustrates an example storage medium with instructions configured to enable a computer-assisted or autonomous driving system to practice the present disclosure, in accordance with various embodiments.

### DETAILED DESCRIPTION

Apparatuses, methods and storage media associated with autonomously or semi-autonomously parking a vehicle are disclosed herein. In embodiments, an apparatus may include a communication interface to receive sensor data associated with environmental condition of an area around or adjacent to a vehicle; and a parking condition analysis unit coupled to the communication interface to determine, while the vehicle is parked in a current parking position, whether there is a new parking position for the vehicle, that provides a new parking condition that is an improvement over a current parking condition of the current parking position of the vehicle, based at least in part on the received sensor data.

In embodiments, the parking condition analysis unit is to conclude the new parking position will provide the new parking condition that is an improvement over the current parking condition of the current parking position of the vehicle, if the new parking position will provide more shade coverage for the vehicle then the current parking position, e.g., due to movement of a shade from substantially covering the current parking position, to more substantially covering the new parking position.

In embodiments, the sensor data may comprise camera data, radiation temperature data, or Global Positioning System (GPS) data, e.g., camera data, radiation temperature data or GPS data collected respectively by a camera, a radiation temperature sensor or a GPS sensor, disposed in the vehicle.

In embodiments, the apparatus may be a computer-assisted or autonomous driving system disposed in the vehicle, or the vehicle itself, which may be an autonomous or semi-autonomous vehicle. In embodiments, the vehicle may be an electric vehicle having a battery, such as, a Li-ion battery, or a combustion engine vehicle.

In embodiments, the parking condition analysis unit is to further determine, prior to the vehicle is parked in the current parking position, that the current parking position is a parking position among a plurality of potential parking positions that provides an overall optimal parking condition over an expected amount of the time the vehicle will be parked.

In the description to follow, reference is made to the accompanying drawings, which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Operations of various methods may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiments. Various additional operations may be performed and/or described operations may be omitted, split or combined in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used hereinafter, including the claims, the term “module” may refer to, be part of, or include an Application Specific Integrated Circuit (ASIC), an electronic circuit, a programmable combinational logic circuit (e.g., field programmable gate arrays (FPGA)), a processor (shared, dedicated, or group) and/or memory (shared, dedicated, or group) that execute one or more software or firmware programs generated from a plurality of programming instructions and/or other suitable components that provide the described functionality.

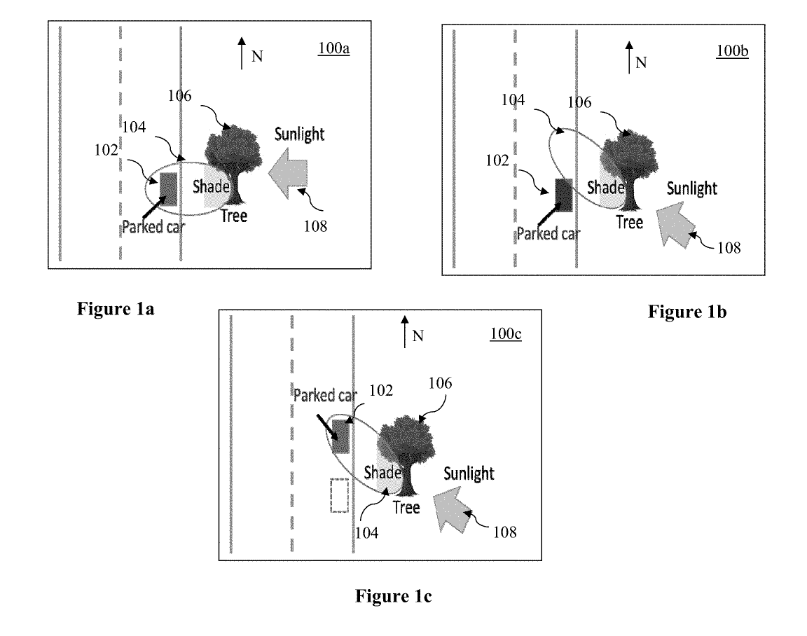

Referring now FIG. 1a-1c, wherein an overview of autonomous or semi-autonomous parking of a vehicle, in accordance with various embodiments, is shown. As illustrated in FIG. 1a, at time 100a, autonomous or semi-autonomous (A/SA) vehicle 102 may be initially parked at a location covered by shade 104 in part or in whole. For the embodiments, shade 104 may be created by tree 106 as a result of sunlight 108 being coming from the other direction (the easterly direction in the illustration).

As illustrated in FIG. 1b, at a later point in time 100b, by virtue of the movement of the earth relative to the sun, sunlight 108 may be coming from a different other direction (the south-east direction in the illustration) instead. As a result, shade 104 has moved from the prior location that covers parked A/SA vehicle 102 to a new location that no longer or marginally covers parked A/SA vehicle 102.

In response to the movement of shade 104, as illustrated in FIG. 1c, parked A/SA vehicle 102 equipped with a computer-aided or autonomous driving (CA/AD) system having the autonomous or semi-autonomous parking technology of the present disclosure may autonomously or semi-autonomously detect the deterioration of the current parking condition of the current parking position, identify the new parking position as a parking position that can provide a new parking condition that is an improvement over the current parking condition (by virtue of the moved shade 104), and move itself, park at the new parking location, and be substantially covered by shade 104 again.

In embodiments, A/SA vehicle 102 may be an electric vehicle with a battery, such as a Li-ion battery, which battery longevity may be substantially benefited from not being exposed to higher temperature as a result of not being directly exposed to sunlight 108. In addition, the interior compartment of electric CA/AD vehicle 102 may also be benefited, allowing the interior compartment to provide a lower temperature environment by not being directly exposed to sunlight 108. Thus, the present disclosure is not limited to electric vehicles, in embodiments, A/SA vehicle 102 may be a combustion engine vehicle, which interior compartment may similarly be benefited with the autonomous or semi-autonomous parking technology of the present disclosure.

As will be described in more detail below, the CA/AD system of A/SA vehicle 102, equipped with the autonomous or semi-autonomous parking technology of the present disclosure, may be configured to receive sensor data associated with environmental condition of an area around or adjacent to A/SA vehicle 102, while the vehicle is parked in a current parking position. Further, the CA/AD system of A/SA vehicle 102 may continuously or periodically determine if there is a new parking position for A/SA vehicle 102, that provides a new parking condition that is an improvement over a current parking condition of the current parking position of A/SA vehicle 102, based at least in part on the received sensor data. In embodiments, the CA/AD system of A/SA vehicle 102 may be configured to conclude the new parking position will provide the new parking condition that is an improvement over the current parking condition of the current parking position of the vehicle, if the new parking position will provide more shade coverage for the A/SA vehicle 102 then the current parking position.

In embodiments, the CA/AD system of A/SA vehicle 102 may be further configured to determine, prior to the vehicle is parked at a parking position, that the parking position is a parking position among a plurality of potential parking positions that provides an overall optimal parking condition, such as an overall optimal among of shade coverage over an expected amount of the time the vehicle will be parked, thereby potentially reducing a likelihood of need to move the parked vehicle to provide improved parking condition. For example, if a first open parking position currently provides shade coverage but expects to last only a couple of hours while the vehicle is parked, and a second open parking position currently provides no shade coverage but expect to provide more than a couple of hours of coverage later on while the vehicle is parked, the CA/AD system of A/SA vehicle 102 may select the second open parking position over the first open parking position to park A/SA vehicle 102 instead.

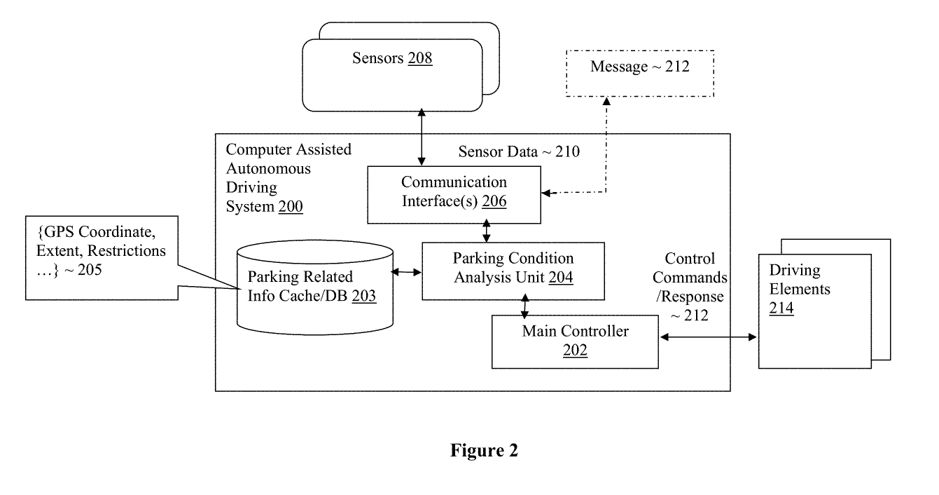

Referring now to FIG. 2, wherein a block diagram view of an example CA/AD system, in accordance with various embodiments, is shown. As illustrated, CA/AD system 200 may include one or more communication interfaces 206, parking condition analysis unit 204, parking related information cache/database 203, and main controller 202 coupled with each other as shown.

In embodiments, one of the one or more communication interfaces 206 may be configured to receive various sensor data 210 from sensors 208. In embodiments, sensor data 210 may comprise camera data, radiation temperature data, or GPS data, e.g., camera data, radiation temperature data, or GPS data collected respectively by a camera, a radiation temperature sensor or a GPS sensor 208, disposed in A/SA vehicle 102. In embodiments, one of the one or more communication interfaces 206 may be configured to optionally send and receive messages 212 to an owner, a driver and/or a passenger of A/SA vehicle 102, in particular, messages related to the parking condition of A/SA vehicle 102, including e.g., requests for authorization and authorizations to move the parked A/SA vehicle 102. The owner, the driver and/or the passenger may be temporarily away from the parked A/SA vehicle 102. If implemented, whether the request for authorization message is sent to the owner, the driver and/or the passenger may be configurable by the owner, the driver and/or the passenger.

In embodiments, one or more communication interfaces 206 may include a communication interface, such as a I² bus, an Integrated Drive Electronic (IDE) bus, a Serial Advanced Technology Attachment (SATA) bus, a Peripheral Component Interconnect (PCI) bus, a Universal Serial Bus (USB), a Near Field Communication (NFC) interface, a Bluetooth® interface, WiFi, and so forth, for receiving sensor data 210 from sensors 208. In embodiments, one or more communication interfaces 206 may include a communication interface, such as 3G/4G, or LTE, to send and receive messages from a mobile or stationary device of the owner, the driver or the passenger of CA/AD vehicle 102. An example of a mobile device may be a smartphone, a tablet or a laptop computer of the owner, the driver or the passenger of CA/AD vehicle 102. An example of a stationary device may be a desktop computer, a set-top box, a television of the owner, the driver or the passenger of CA/AD vehicle 102.

Still referring to FIG. 2, in embodiments, parking condition analysis unit 204 may be configured to receive sensor data 210 of the environmental condition of the area around or adjacent to A/SA vehicle 102, via communication interface(s) 206, while A/SA vehicle 102 is parked. Further, parking condition analysis unit 204 may be configured to analyze, continuously or periodically, sensor data 210, to determine whether there is a new parking position for A/SA vehicle 102 that provides a new parking condition that is an improvement over a current parking condition of the current parking position of CA/AD vehicle 102.

In embodiments, parking condition analysis unit 204 may be configured to continuously or periodically analyze whether the current parking condition of the current parking position has deteriorated to below or above a parking condition threshold, and commence the process of searching for a new parking position that will provide a new parking condition that is an improvement over the current parking condition, on determination that the current parking condition has deteriorated to below or above the parking condition threshold. For example, parking condition analysis unit 204 may be configured to continuously or periodically analyze the shade coverage or interior temperature of A/SA vehicle 102 to determine whether shade cover has fallen below a predetermined shade coverage threshold or the interior temperature has risen above a predetermined temperature threshold. If the search for a potentially better new parking position is to be performed periodically, the periodicity may be configurable by the owner, the driver and/or the passenger of the A/SA vehicle 102.

In embodiments, as described earlier, parking condition analysis unit 204 may be configured to conclude the new parking position will provide the new parking condition that is an improvement over the current parking condition of the current parking position of the vehicle, if the new parking position will provide more shade coverage for the vehicle then the current parking position.

In embodiments, parking condition analysis unit 204 may be configured to identify the new parking position by analyzing camera or radar images for empty spaces. In embodiments, parking condition analysis unit 204 may be configured to not only identify a position or location as being unoccupied, but also identify (e.g., through analysis of camera or radar images) that the position/location is of sufficient size for the CA/AD vehicle 102 to park there. In embodiments, parking condition analysis unit 204 may be further configured to determine whether the new available/compatible position or location is a legal parking space under local laws and/or regulations.

In embodiments, cache/database 203 may be configured to store local parking related information. For example, cache/database 203 may be configured to store local parking related information for a city or a neighborhood. In embodiments, the stored information 205 may include records of various locations within the city or neighborhood in terms of regulations and/or restrictions that are applicable to the various locations. For example, each record may include a GPS coordinate (latitude and longitude), an extent (e.g., in length), and applicable restrictions (e.g., the extent is within the restricted distance from a stop sign, the extent is within the restricted distance from a fire hydrant, the extent is a truck loading/unloading zone, the extent is a passenger loading/unloading zone, and so forth). In embodiments, parking restriction information of a relatively large geographic area, e.g., a city, a metropolitan area, or a state may be pre-loaded into cache/database 203. In embodiments, parking restriction information of a neighborhood may be dynamically cached into cache/database 203 based on the current location of A/SA vehicle 102.

In embodiments, parking condition analysis unit 204 may be configured to access the parking restriction information 205 in cache/database 203 when making its determination whether an available/compatible position or location is a legal parking space under local laws and/or regulations. In alternate embodiments, parking condition analysis unit 204 may be configured to access a remote database (not shown) with such information, via communication interface 206, instead.

Continuing to refer to FIG. 2, in embodiments, parking condition analysis unit 204 may be further configured to output for main controller 202, a result of the analysis including availability, identification and/or description of a new legal parking position that might provide improved parking condition, on determining the existence of such new legal parking position. In embodiments, main controller 202 may be configured to issue control commands 212 to driving elements 214 of ANSA vehicle 102 (e.g., engine, brake, and so forth) to move ANSA vehicle 102 to the new legal parking position, on receipt of the result of the analysis from parking condition analysis unit 204.

In alternate embodiments, parking condition analysis unit 204 may be configured to first send a request for authorization message 212 to obtain authorization from the owner, driver and/or passenger to move/re-park ANSA vehicle 102, before outputting the result of the analysis for main controller 202, to cause main controller 202 to issue commands 212 to driving elements 214 to move/re-park ANSA vehicle 102.

In embodiments, parking condition analysis unit 204 may be further configured to send a message to the owner, driver or passenger of ANSA vehicle 102 to notify the owner, driver and/or passenger of ANSA vehicle 102 of the fact that the ANSA vehicle 102 has been moved/re-parked, for either case, regardless whether the movement/re-park was caused with or without prior authorization from the owner, driver and/or passenger of ANSA vehicle 102.

In embodiments, parking condition analysis unit 204 may be further configured to determine, prior to the vehicle is parked at a parking position, that the parking position is a parking position among a plurality of potential parking positions that provides an overall optimal parking condition, such as an overall optimal among of shade coverage over an expected amount of the time the vehicle will be parked, thereby potentially reducing a likelihood of need to move the parked vehicle to provide improved parking condition. In embodiments, parking condition analysis unit 204 may be further configured to predict amounts of shade coverage at different points in time over the expected amount of the time the vehicle will be parked, based at least in part on one or more factors that include time of day, season of the year, locations of the potential parking positions, objects around the potential parking positions or buildings around the potential parking positions. These and other factors help determine the direction of light and the shade coverage, both in terms of size of coverage and/or duration of coverage. For some of these embodiments, parking condition analysis unit 204 may be configured to track time of day and/or season of the year, and parking related information cache/database 203 may be further configured to store information about objects, such as trees, billboards, signs and so forth, and buildings surrounding various potential parking positions.

In embodiments, parking condition analysis unit 204 and main controller 202 may be implemented in hardware, e.g., ASIC, or programmable combinational logic circuit (e.g., (FPGA)), or software (to be executed by a processor and memory arrangement), or combination thereof. For software implementations, in some embodiments, parking analysis unit 204 and main controller 202 may share a common execution environment provided by the same processor and memory arrangement. In alternate embodiments, parking analysis unit 204 and main controller 202 may be implemented to operate in different execution environments, e.g., parking analysis unit 204 to operate in a general execution environment for applications, and main controller 202 to operate in a separate trusted/secured execution environment, that is separate, isolated and protected from the general execution environment for applications.

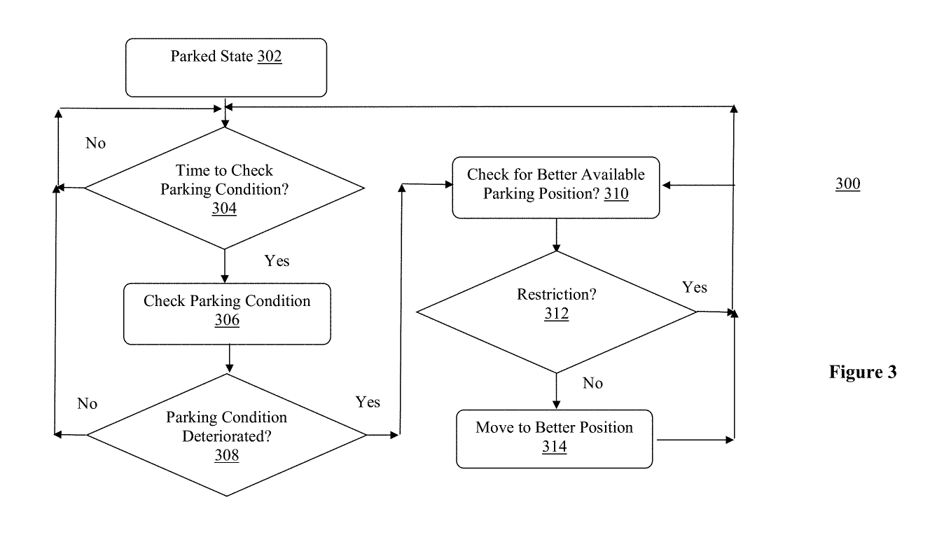

Referring now to FIG. 3, wherein an example process for autonomously or semi-autonomously parking a vehicle, in accordance with various embodiments, is shown. As illustrated, process 300 for autonomously or semi-autonomously parking a vehicle may include operations performed in blocks 302-314. The operations may be performed by e.g., parking analysis unit 204 and main controller 202 of CA/AD system 200 of FIG. 2. In alternate embodiments, process 300 for autonomously or semi-autonomously parking a vehicle may include more or less operations, or have some of the operations performed in different order.

Process 300 may start at block 302 when an A/SA vehicle is in a parked state. At block 304, a check may be performed to determine whether current parking condition is to be analyzed. If the current parking condition is to be analyzed, process 300 may proceed to block 306, else process 300 may loop through block 304 again. Whether the parking condition is to be checked continuously or periodically, and if periodically, how frequent, may be implementation dependent and/or configurable by the owner, the driver and/or the passenger of the A/SA vehicle 102.

At block 306, a check may be performed on the current parking condition. As described earlier, the check may check on the current amount of shade coverage of the ANSA vehicle or the temperature of the interior cabin of the ANSA vehicle. Next, at block 308, a determination may be made on whether the current parking condition has deteriorated to below or above a parking condition threshold. For example, a determination may be made on whether the percentage of shade coverage has receded to below a shade coverage threshold, e.g., less than 50%, or whether the temperature within the interior cabin of the ANSA vehicle has risen to above a temperature threshold, e.g., above 80 degrees Fahrenheit.

If a result of determination at block 308 indicates that the current parking condition has deteriorated to below or above a parking condition threshold, process 300 may proceed to block 310, else process 300 may iterate back to block 304, and continue there from as earlier described. At block 301, a search may be performed to determine whether there is a new parking position that may provide a new parking condition that is an improvement over the current parking condition.

As described earlier, to search for the new parking position, an analysis may be performed on the sensor data received for the surrounding or adjacent area of the ANSA vehicle. For example, camera and/or radar images may be analyzed to determine whether there is an empty space of adequate size with more shade coverage that can accommodate the ANSA vehicle. On determining the available of a suitable empty space that may provide an improvement on the parking condition, at block 312, a further determination may be performed on whether there are any parking restriction on the available suitable space.

If there are parking restrictions on the otherwise available suitable space, process 300 may return to block 310 and continued therefrom to search for another available suitable space. If the search has exhausted all possible available suitable spaces nearby, process 300 may return to block 304, and continue therefrom as described earlier.

On the other hand, if there are no parking restriction on the available suitable space, at block 314, the ANSA vehicle may be moved from the current parking position to the new parking position to potentially provide a new parking condition that could be an improvement over the current parking condition. In embodiments, as described earlier, an authorization from an owner, driver and/or passenger may be sought first before moving the ANSA vehicle to the new parking position.

In alternate embodiments, process 300 may further comprise determining, prior to the vehicle is parked at a parking position and determine whether it is time to check parking condition at block 304, that the parking position is a parking position among a plurality of potential parking positions that provides an overall optimal parking condition, such as an overall optimal among of shade coverage over an expected amount of the time the vehicle will be parked, thereby potentially reducing a likelihood of need to move the parked vehicle to provide improved parking condition. As described earlier, the determining may be based at least in part on time of day, season of the year, and/or objects/building surrounding the plurality of potential parking positions. These and other factors help determine the direction of light and the shade coverage, both in terms of size of coverage and/or duration of coverage

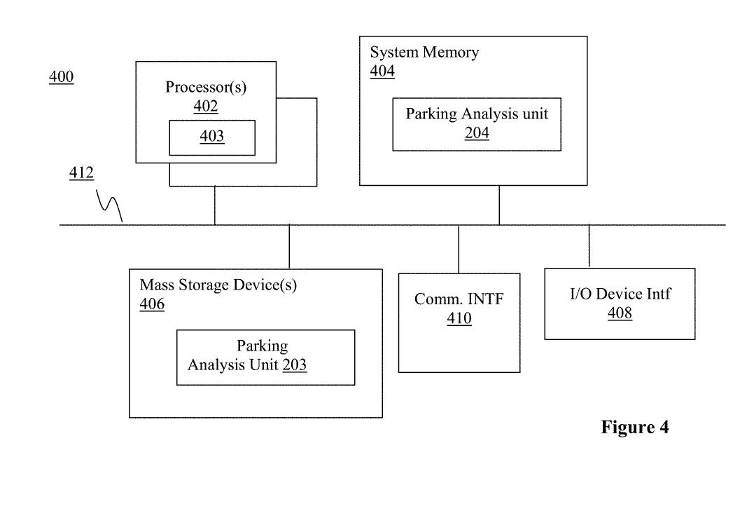

Referring now to FIG. 4, wherein a block diagram of a computer device suitable for practice aspects of the present disclosure, in accordance with various embodiments, is illustrated. As shown, in embodiments, computer device 400 may include one or more processors 402 and system memory 404. Each processor 402 may include one or more processor cores. In embodiments, one or more processors 402 may include one or more hardware accelerators (such as, FPGA). System memory 404 may include any known volatile or non-volatile memory. Additionally, computer device 400 may include mass storage device(s) 406 (such as solid state drives), input/output device interface 408 (to interface with e.g., sensors) and communication interfaces 410 (such as network interface cards, modems and so forth, to interface with e.g., devices associated with the owner, driver or passenger of the A/SA vehicle). The elements may be coupled to each other via system bus 412, which may represent one or more buses. In the case of multiple buses, they may be bridged by one or more bus bridges (not shown).

Each of these elements may perform its conventional functions known in the art. In particular, system memory 404 and mass storage device(s) 406 may be employed to store a working copy and a permanent copy of the executable code of the programming instructions implementing the operations described earlier, e.g., but are not limited to, operations associated with parking analysis unit 204 of FIG. 2. The programming instructions may comprise assembler instructions supported by processor(s) 402 or high-level languages, such as, for example, C, that can be compiled into such instructions. In embodiments, some of the functions performed by parking analysis unit 204 may be implemented with hardware processor 403 instead.

The permanent copy of the executable code of the programming instructions and/or the bit streams to configure hardware accelerator 403 may be placed into permanent mass storage device(s) 406 or hardware accelerator 403 in the factory, or in the field, through, for example, a distribution medium (not shown), such as a compact disc (CD), or through communication interface 410 (from a distribution server (not shown)).

Except for the use of computer system 400 to host parking analysis unit 204, the constitutions of the elements 510-512 are otherwise known, and accordingly will not be further described.

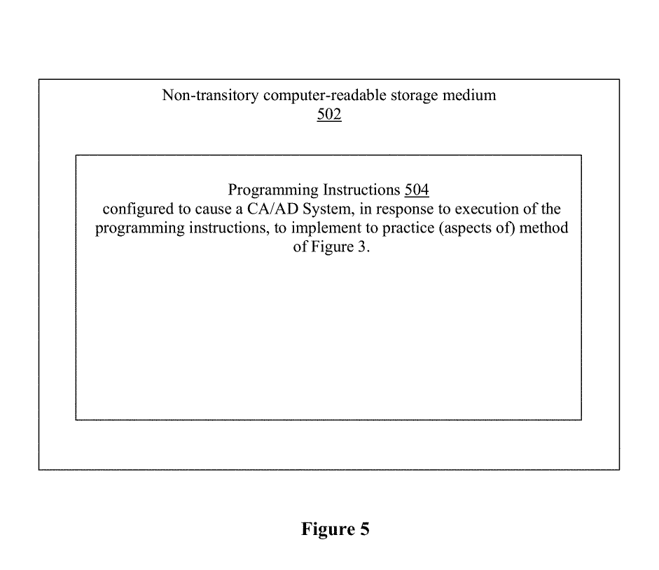

Referring now to FIG. 5, wherein an example non-transitory computer-readable storage medium having instructions configured to practice all or selected ones of the operations associated with autonomous or semiautonomous parking, earlier described, in accordance with various embodiments, is shown. As illustrated, non-transitory computer-readable storage medium 502 may include the executable code of a number of programming instructions 504. Executable code of programming instructions 504 may be configured to enable a system, e.g., CA/AD system 200 or computer system 400, in response to execution of the executable code/programming instructions, to perform, e.g., various operations associated autonomous or semi-autonomous parking described with references to FIGS. 1-3. In alternate embodiments, executable code/programming instructions 504 may be disposed on multiple non-transitory computer-readable storage medium 502 instead. In still other embodiments, executable code/programming instructions 504 may be encoded in transitory computer readable medium, such as signals.

In embodiments, a processor may be packaged together with a computer-readable storage medium having some or all of executable code of programming instructions 504 configured to practice all or selected ones of the operations earlier described with references to FIG. 1-3. For one embodiment, a processor may be packaged together with such executable code 504 to form a System in Package (SiP). For one embodiment, a processor may be integrated on the same die with a computer-readable storage medium having such executable code 504. For one embodiment, a processor may be packaged together with a computer-readable storage medium having such executable code 504 to form a System on Chip (SoC). For at least one embodiment, the SoC may be utilized in, e.g., CA/AD system 200.

Thus, an improved method and apparatus for autonomous or semi-autonomous parking has been described. The approach may be especially helpful for electric vehicles with batteries, such as Li-ion batteries, which useful lives are sensitive to the temperature of their operating conditions.

Example 1 may be an apparatus for autonomous or semi-autonomous driving, comprising: a communication interface to receive sensor data associated with environmental condition of an area around, adjacent or interior to a vehicle; and a parking condition analysis unit coupled to the communication interface to determine, while the vehicle is parked in a current parking position, whether there is a new parking position for the vehicle, that provides a new parking condition that is an improvement over a current parking condition of the current parking position of the vehicle, based at least in part on the received sensor data.

Example 2 may be example 1, wherein the parking condition analysis unit may conclude the new parking position will provide the new parking condition that is an improvement over the current parking condition of the current parking position of the vehicle, if the new parking position will provide more shade coverage for the vehicle then the current parking position.

Example 3 may be example 1, wherein the parking condition analysis unit may perform the determination periodically, while the vehicle is parked in the current parking position.

Example 4 may be example 1, wherein the parking condition analysis unit may determine whether the current parking condition of the current parking position of the vehicle has deteriorated below or above a parking condition threshold.

Example 5 may be example 4, wherein the parking condition analysis unit may search for the new parking position, in response to a determination result that indicates the current parking condition of the current parking position of the vehicle has deteriorated below a parking condition threshold.

Example 6 may be example 1, wherein to determine, while the vehicle is parked in the current parking position, whether there is a new parking position for the vehicle, that provides the new parking condition that is an improvement over the current parking condition of the current parking position of the vehicle, may include to determine a current direction of sunlight.

Example 7 may be example 1, wherein the apparatus is a computer-assisted or autonomous driving system disposed in the vehicle, and may further include a main controller coupled to the parking condition analysis unit; wherein the parking condition analysis unit is to further transmit a message, via the communication interface, to an owner, a driver, or a passenger of the vehicle, in response to a determination of the new parking position for the vehicle, that provides the new parking condition that is an improvement over the current parking condition of the current parking position of the vehicle.

Example 8 may be example 7, wherein the parking condition analysis unit may further receive a message from the owner, the driver, or the passenger of the vehicle, to move the vehicle from the current parking position to the new parking position, and relay the message from the owner, the driver, or the passenger of the vehicle to the main controller to move the vehicle from the current parking position to the new parking position.

Example 9 may be example 8, wherein the main controller may output commands to driving elements of the vehicle to move the vehicle from the current parking position to the new parking position, in response to receipt of the message relayed from the parking condition analysis unit.

Example 10 may be example 1, wherein the apparatus is a computer-assisted or autonomous driving system disposed in the vehicle, and may further include a main controller coupled to the parking condition analysis unit; wherein the parking condition analysis unit may further transmit a message to the main controller, in response to a determination of the new parking position for the vehicle, that provides the new parking condition that is an improvement over the current parking condition of the current parking position of the vehicle; and wherein the main controller may output commands to driving elements of the vehicle to move the vehicle from the current parking position to the new parking position, in response to receipt of the message relayed from the parking condition analysis unit.

Example 11 may be any one of example a1-10, wherein the vehicle may be an electrical vehicle having a battery.

Example 12 may be any one of examples 1-10, wherein the sensor data may comprise camera data, radiation temperature data, or Global Positioning System data.

Example 13 may be example 1-6, wherein the sensor data may comprise camera data, radiation temperature data or Global Positioning System data; and the vehicle may be an autonomous driving vehicle having a camera to output the camera data, a radiation temperature sensor to output the radiation temperature data, or a Global Positioning System to output the Global Positioning System data, and wherein the apparatus is the autonomous driving vehicle.

Example 14 is a method for autonomous or semi-autonomous driving, comprising: receiving, by a computer-assisted or autonomous driving system disposed in a vehicle, sensor data associated with environmental condition of an area around, adjacent or interior to the vehicle; and determining, by the computer-assisted or autonomous driving system, while the vehicle is parked in a current parking position, whether there is a new parking position for the vehicle, that provides more shade coverage for the vehicle then the current parking position, based at least in part on the received sensor data.

Example 15 may be example 14, wherein determining may be performed periodically, while the vehicle is parked in the current parking position.

Example 16 may be example 14, wherein determining may comprise determining whether an amount of shade coverage of the current parking position of the vehicle has deteriorated below a parking condition threshold.

Example 17 may be example 14, wherein determining may comprise determining whether interior cabin temperature of the vehicle parked at the current parking position of the vehicle has deteriorated to above an interior cabin temperature threshold.

Example 18 may be example 14, wherein determining may comprise determining a current direction of sunlight.

Example 19 may be example 14, further comprising transmitting, by the computer-assisted or autonomous driving system, a message to an owner, a driver, or a passenger of the vehicle, in response to the determining of the new parking position for the vehicle, that provides the new parking condition that is an improvement over the current parking condition of the current parking position of the vehicle.

Example 20 may be example 19, further comprising receiving, by the computer-assisted or autonomous driving system, a message from the owner, the driver, or the passenger of the vehicle, to move the vehicle from the current parking position to the new parking position, and in response to the receipt, moving the vehicle from the current parking position to the new parking position.

Example 21 may be example 14-20, wherein the sensor data may comprise camera data, radiation temperature data or Global Positioning system data.

Example 22 is at least one computer readable media (CRM) comprising a plurality of instructions arranged to cause a computer-assisted or autonomous driving system disposed in a vehicle, in response to execution of the instructions, to: receive, sensor data from sensors disposed in the vehicle; and determine, while the vehicle is parked in a current parking position, whether there is a new parking position for the vehicle, that provides a new parking condition that is an improvement over a current parking condition of the current parking position of the vehicle, based at least in part on the received sensor data.

Example 23 may be example 22, wherein to determine may be performed periodically, while the vehicle is parked in the current parking position.

Example 24 may be example 22, wherein to determine may comprise to determine whether an amount of shade coverage of the current parking position of the vehicle has deteriorated below a parking condition threshold.

Example 25 may be example 22, wherein to determine may comprise to determine whether interior cabin temperature of the vehicle parked at the current parking position of the vehicle has deteriorated to above an interior cabin temperature threshold.

Example 26 may be example 22, wherein to determine may comprise to determine a current direction of sunlight.

Example 27 may be example 22, wherein the computer-assisted or autonomous driving system may be further caused to transmit a message to an owner, a driver, or a passenger of the vehicle, in response to the determination of the new parking position for the vehicle, that provides the new parking condition that is an improvement over the current parking condition of the current parking position of the vehicle.

Example 28 may be example 27, wherein the computer-assisted or autonomous driving system may be further caused to receive a message from the owner, the driver, or the passenger of the vehicle, to move the vehicle from the current parking position to the new parking position, and in response to the receipt, move the vehicle from the current parking position to the new parking position.

Example 29 may be any one of examples 22-28, wherein the sensor data may comprise camera data, radiation temperature data or Global Positioning System data collected by a camera, a radiation temperature data or a Global Positioning System sensor of the vehicle.

Example 30 may be an apparatus for autonomous or semi-autonomous driving, comprising: means for receiving sensor data associated with environmental condition of an area around or adjacent to a vehicle; and means for determining, while the vehicle is parked in a current parking position, whether there is a new parking position for the vehicle, that provides more shade coverage for the vehicle over a current parking condition of the current parking position of the vehicle, based at least in part on the received sensor data.

Example 31 may be example 30, wherein the means for determining may comprise means for determining periodically, while the vehicle is parked in the current parking position.

Example 32 may be example 30, wherein the means for determining may comprise means for determining whether an amount of shade coverage of the current parking position of the vehicle has deteriorated below a parking condition threshold.

Example 33 may be example 30, wherein the means for determining may comprise means for determining whether interior cabin temperature of the vehicle parked at the current parking position of the vehicle has deteriorated to above an interior cabin temperature threshold.

Example 34 may be example 30, wherein the means for determining may comprise means for determining a current direction of sunlight.

Example 35 may be example 30, further comprising means for transmitting, a message to an owner, a driver, or a passenger of the vehicle, in response to the determining of the new parking position for the vehicle that provides the new parking condition that is an improvement over the current parking condition of the current parking position of the vehicle.

Example 36 may be example 35, further comprising means for receiving a message from the owner, the driver, or the passenger of the vehicle, to move the vehicle from the current parking position to the new parking position, and in response to the receipt, moving the vehicle from the current parking position to the new parking position.

Example 37 may be any one of examples 30-36, wherein the sensor data may comprise camera data, radiation temperature data or Global Positioning system data.

Example 38 may be example 1, wherein the parking condition analysis unit is to further determine, prior to the vehicle is parked in the current parking position, that the current parking position is a parking position among a plurality of potential parking positions that provides an overall optimal parking condition over an expected amount of the time the vehicle will be parked.

Example 39 may be example 38, wherein to determine, prior to the vehicle is parked in the current parking position, that the current parking position is a parking position among a plurality of potential parking positions that provides an overall optimal parking condition over an expected amount of the time the vehicle will be parked comprises to determine, prior to the vehicle is parked in the current parking position, that the current parking position is the parking position among the plurality of potential parking positions that provides an overall optimal amount of shade coverage for the vehicle over the expected amount of the time the vehicle will be parked.

Example 40 may be example 38, wherein to determine, prior to the vehicle is parked in the current parking position, that the current parking position is the parking position among the plurality of potential parking positions that provides an overall optimal amount of shade coverage for the vehicle over the expected amount of the time the vehicle will be parked comprises to predict amounts of shade coverage at different points in time over the expected amount of the time the vehicle will be parked, based at least in part on one or more factors that include time of day, season of the year, locations of the potential parking positions, objects around the potential parking positions or buildings around the potential parking positions.

Example 41 may be example 14, further comprising determining, prior to the vehicle is parked in the current parking position, that the current parking position is a parking position among a plurality of potential parking positions that provides an overall optimal amount of shade coverage over an expected amount of the time the vehicle will be parked.

Example 42 may be example 41, wherein determining, prior to the vehicle is parked in the current parking position, that the current parking position is the parking position among the plurality of potential parking positions that provides an overall optimal amount of shade coverage for the vehicle over the expected amount of the time the vehicle will be parked comprises predicting amounts of shade coverage at different points in time over the expected amount of the time the vehicle will be parked, based at least in part on one or more factors that include time of day, season of the year, locations of the potential parking positions, objects around the potential parking positions or buildings around the potential parking positions.

Example 43 may be example 22, wherein the computer-assisted or autonomous driving system is further caused to determine, prior to the vehicle is parked in the current parking position, that the current parking position is a parking position among a plurality of potential parking positions that provides an overall optimal parking condition over an expected amount of the time the vehicle will be parked.

Example 44 may be example 43, wherein to determine, prior to the vehicle is parked in the current parking position, that the current parking position is a parking position among a plurality of potential parking positions that provides an overall optimal parking condition over an expected amount of the time the vehicle will be parked comprises to determine, prior to the vehicle is parked in the current parking position, that the current parking position is the parking position among the plurality of potential parking positions that provides an overall optimal amount of shade coverage for the vehicle over the expected amount of the time the vehicle will be parked.

Example 45 may be example 44, wherein to determine, prior to the vehicle is parked in the current parking position, that the current parking position is the parking position among the plurality of potential parking positions that provides an overall optimal amount of shade coverage for the vehicle over the expected amount of the time the vehicle will be parked comprises to predict amounts of shade coverage at different points in time over the expected amount of the time the vehicle will be parked, based at least in part on one or more factors that include time of day, season of the year, locations of the potential parking positions, objects around the potential parking positions or buildings around the potential parking positions.

Example 46 may be example 30, further comprising means for determining, prior to the vehicle is parked in the current parking position, that the current parking position is a parking position among a plurality of potential parking positions that provides an overall optimal amount of shade coverage over an expected amount of the time the vehicle will be parked.

Example 47 may be example 46, wherein means for determining, prior to the vehicle is parked in the current parking position, that the current parking position is the parking position among the plurality of potential parking positions that provides an overall optimal amount of shade coverage for the vehicle over the expected amount of the time the vehicle will be parked comprises means for predicting amounts of shade coverage at different points in time over the expected amount of the time the vehicle will be parked, based at least in part on one or more factors that include time of day, season of the year, locations of the potential parking positions, objects around the potential parking positions or buildings around the potential parking positions.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

What is claimed is:

1. An apparatus for autonomous or semi-autonomous driving, comprising:
a communication interface to receive sensor data associated with environmental condition of an area around, adjacent or interior to a vehicle; and
a parking condition analysis unit coupled to the communication interface to determine, while the vehicle is parked in a current parking position, whether there is a new parking position for the vehicle, that provides a new parking condition that is an improvement over a current parking condition of the current parking position of the vehicle, based at least in part on the received sensor data.

2. The apparatus of claim 1, wherein the parking condition analysis unit is to conclude the new parking position will provide the new parking condition that is an improvement over the current parking condition of the current parking position of the vehicle, if the new parking position will provide more shade coverage for the vehicle then the current parking position.

3. The apparatus of claim 1, wherein the parking condition analysis unit is to perform the determination periodically, while the vehicle is parked in the current parking position.

4. The apparatus of claim 1, wherein the parking condition analysis unit is to determine whether the current parking condition of the current parking position of the vehicle has deteriorated below or above a parking condition threshold.

5. The apparatus of claim 4, wherein the parking condition analysis unit is to search for the new parking position, in response to a determination result that indicates the current parking condition of the current parking position of the vehicle has deteriorated below a parking condition threshold.

6. The apparatus of claim 1, wherein to determine, while the vehicle is parked in the current parking position, whether there is a new parking position for the vehicle, that provides the new parking condition that is an improvement over the current parking condition of the current parking position of the vehicle, includes to determine a current direction of sunlight.

7. The apparatus of claim 1, wherein the apparatus is a computer-assisted or autonomous driving system disposed in the vehicle, and further includes a main controller coupled to the parking condition analysis unit; wherein the parking condition analysis unit is to further transmit a message, via the communication interface, to an owner, a driver, or a passenger of the vehicle, in response to a determination of the new parking position for the vehicle, that provides the new parking condition that is an improvement over the current parking condition of the current parking position of the vehicle.

8. The apparatus of claim 7, wherein the parking condition analysis unit is to further receive a message from the owner, the driver, or the passenger of the vehicle, to move the vehicle from the current parking position to the new parking position, and relay the message from the owner, the driver, or the passenger of the vehicle to the main controller to move the vehicle from the current parking position to the new parking position.

9. The apparatus of claim 8, wherein the main controller is to output commands to driving elements of the vehicle to move the vehicle from the current parking position to the new parking position, in response to receipt of the message relayed from the parking condition analysis unit.

10. The apparatus of claim 1, wherein the apparatus is a computer-assisted or autonomous driving system disposed in the vehicle, and further includes a main controller coupled to the parking condition analysis unit; wherein the parking condition analysis unit is to further transmit a message to the main controller, in response to a determination of the new parking position for the vehicle, that provides the new parking condition that is an improvement over the current parking condition of the current parking position of the vehicle; and wherein the main controller is to output commands to driving elements of the vehicle to move the vehicle from the current parking position to the new parking position, in response to receipt of the message relayed from the parking condition analysis unit.

11. The apparatus of any one of claims 1, wherein the vehicle is an electrical vehicle having a battery.

12. The apparatus of claim 1, wherein the sensor data comprises camera data, radiation temperature data or Global Positioning System data; and the vehicle is an autonomous driving vehicle having a camera to output the camera data, a radiation temperature sensor to output the radiation temperature data, or a Global Positioning System to output the Global Positioning System data, and wherein the apparatus is the autonomous driving vehicle.

13. A method for autonomous or semi-autonomous driving, comprising:
receiving, by a computer-assisted or autonomous driving system disposed in a vehicle, sensor data associated with environmental condition of an area around, adjacent or interior to the vehicle; and
determining, by the computer-assisted or autonomous driving system, while the vehicle is parked in a current parking position, whether there is a new parking position for the vehicle, that provides more shade coverage for the vehicle then the current parking position, based at least in part on the received sensor data.

14. The method of claim 13, wherein determining is performed periodically, while the vehicle is parked in the current parking position.

15. The method of claim 13, wherein determining comprises determining whether an amount of shade coverage of the current parking position of the vehicle has deteriorated below a parking condition threshold.

16. The method of claim 13, wherein determining comprises determining whether interior cabin temperature of the vehicle parked at the current parking position of the vehicle has deteriorated to above an interior cabin temperature threshold.

17. The method of claim 13, wherein determining comprises determining a current direction of sunlight.

18. The method of claim 13, further comprising transmitting, by the computer-assisted or autonomous driving system, a message to an owner, a driver, or a passenger of the vehicle, in response to the determining of the new parking position for the vehicle, that provides the new parking condition that is an improvement over the current parking condition of the current parking position of the vehicle; and receiving, by the computer-assisted or autonomous driving system, a message from the owner, the driver, or the passenger of the vehicle, to move the vehicle from the current parking position to the new parking position, and in response to the receipt, moving the vehicle from the current parking position to the new parking position.

19. At least one computer readable media (CRM) comprising a plurality of instructions arranged to cause a computer-assisted or autonomous driving system disposed in a vehicle, in response to execution of the instructions, to:
receive, sensor data from sensors disposed in the vehicle; and
determine, while the vehicle is parked in a current parking position, whether there is a new parking position for the vehicle, that provides a new parking condition that is an improvement over a current parking condition of the current parking position of the vehicle, based at least in part on the received sensor data.

20. The CRM of claim 19, wherein to determine is performed periodically, while the vehicle is parked in the current parking position.

21. The CRM of claim 19, wherein to determine comprises to determine whether an amount of shade coverage of the current parking position of the vehicle has deteriorated below a parking condition threshold.

22. The CRM of claim 19, wherein to determine comprises to determine whether interior cabin temperature of the vehicle parked at the current parking position of the vehicle has deteriorated to above an interior cabin temperature threshold.

23. The CRM of claim 19, wherein to determine comprises to determine a current direction of sunlight.

24. The CRM of claim 19, wherein the computer-assisted or autonomous driving system is further caused to transmit a message to an owner, a driver, or a passenger of the vehicle, in response to the determination of the new parking position for the vehicle, that provides the new parking condition that is an improvement over the current parking condition of the current parking position of the vehicle.

25. The apparatus of claim 1, wherein the parking condition analysis unit is to further determine, prior to the vehicle is parked in the current parking position, that the current parking position is a parking position among a plurality of potential parking positions that provides an overall optimal parking condition over an expected amount of the time the vehicle will be parked.
